(19) United States
(12) Patent Application Publication
(10) Pub. No.: US 2022/0339731 A1
(43) Pub. Date: Oct. 27, 2022

(54) RESISTANCE SPOT WELDING METHOD AND METHOD FOR PRODUCING RESISTANCE SPOT WELD JOINT

(71) Applicant: JFE Steel Corporation, Tokyo (JP)

(72) Inventors: Nao Kawabe, Chiyoda-ku, Tokyo (JP); Hiroshi Matsuda, Chiyoda-ku, Tokyo (JP)

(73) Assignee: JFE Steel Corporation, Tokyo (JP)

(21) Appl. No.: 17/762,486

(22) PCT Filed: Jul. 27, 2020
(86) PCT No.: PCT/JP2020/028615

§ 371 Date: Mar. 22, 2022

(30) Foreign Application Priority Data
Sep. 27, 2019 (JP) 2019-176780

(51) Int. Cl. B23K 11/11; B23K 11/16

(52) U.S. Cl. CPC B23K 11/115; B23K 11/166; B23K 2101/34

(57) ABSTRACT

A resistance spot welding method is disclosed for joining two or more steel sheets including at least one steel sheet having a tensile strength of 980 MPa or higher. The resistance spot welding method involves placing the steel sheets on top of each other to form a set of steel sheets to be welded, clamping the set of steel sheets with a pair of electrodes, and passing a current through the steel sheets while applying pressure thereto to join the steel sheets together. The resistance spot welding method includes an initial welding step of welding by passing a current I1 (kA) satisfying 2×√F1<I1≤10×√F1 while applying a welding force F1 (kN) satisfying 0.2×√t1<F1≤4×√t1, and a main welding step of forming a nugget having a predetermined nugget diameter. Spatter is produced in the initial welding step.

### CROSS REFERENCE TO RELATED APPLICATIONS

This is the U.S. National Phase application of PCT/JP2020/028615, filed Jul. 27, 2020 which claims priority to Japanese Patent Application No. 2019-176780, filed Sep. 27, 2019, the disclosures of these applications being incorporated herein by reference in their entireties for all purposes.

### FIELD OF THE INVENTION

The present invention relates to a resistance spot welding method and a method for producing a resistance spot weld joint.

### BACKGROUND OF THE INVENTION

Resistance spot welding is widely used in assembly of vehicle bodies, such as automobile bodies. The assembly of a single automobile body requires resistance spot welding at thousands of points. Resistance spot welding involves passing a current through, while applying pressure to, two or more steel sheets that are placed on top of each other and clamped by a pair of welding electrodes disposed on the upper and lower sides of the steel sheets, respectively. This forms a nugget of a predetermined size at the interface of the steel sheets, joins the steel sheets together, and produces a weld joint.

In recent years, from the viewpoint of environmental protection, there has been demand for reduced CO2 emissions from automobiles. In an effort to achieve light weight and thus to improve fuel efficiency of automobiles, high strength steel sheets have been used to reduce wall thickness of automobile bodies. The enhanced strength of high strength steel sheets is generally achieved by addition of various alloy elements, as well as a large amount of C, and this leads to increased sensitivity to hydrogen embrittlement. In resistance spot welding, for example, rust preventive oil, moisture, and a coated layer on the steel sheet surface enter a weld metal (molten portion) during the process of melting and solidification in welding, and remain, after cooling, as a hydrogen source that causes the occurrence of delayed fracture.

Therefore, when high strength steel sheets are welded by resistance spot welding, the weld of the resulting weld joint may suffer delayed fracture due to the entry of hydrogen, during welding, into the weld metal that is highly sensitive to hydrogen embrittlement.

The following patent literatures disclose methods for preventing delayed fracture in welds. For example, Patent Literature 1 discloses a technique in which immediately after passage of welding current (main welding), the welding force is increased and the current is decreased to control residual stress in welds and thereby prevent delayed fracture. Also, for example, Patent Literature 2 discloses a technique in which the welding force is increased immediately after passage of welding current (main welding) and the current is passed after a cooling period during which there is no current passage, in such a way as to control the microstructure and hardness of welds and thereby prevent delayed fracture.

### PATENT LITERATURE

PTL 1: Japanese Unexamined Patent Application Publication No. 2015-93282

PTL 2: International Publication No. 2014/171495

### SUMMARY OF THE INVENTION

As described above, resistance spot welding of high strength steel sheets has a problem in that hydrogen enters the weld metal. In resistance spot welding of high strength steel sheets, therefore, it is important not only to improve the strength of the weld Mint, but also to reduce the amount of residual hydrogen in the weld to prevent delayed fracture.

However, the techniques disclosed in Patent Literature 1 and Patent Literature 2 do not involve reducing the amount of hydrogen in the weld to prevent delayed fracture. Also, these techniques have problems in that if the welding force is excessively increased when the nugget is in a molten state immediately after passage of welding current, the sheet thickness at the weld tends to decrease and this may reduce the strength of the resulting weld joint or may affect the appearance of the weld.

The problem of delayed fracture caused by entry of hydrogen, during welding, into the weld metal that is highly sensitive to hydrogen embrittlement, exists not only in the case of resistance spot welding of high strength steel sheets for automobiles, but also in the case of resistance spot welding of other types of steel sheets.

Aspects of the present invention have been made in view of the problems described above. An object according to aspects of the present invention is to provide a resistance spot welding method and a method for producing a resistance spot weld joint that make it possible to stably form a nugget having a large diameter, as well as to suppress delayed fracture in the weld.

To suppress delayed fracture in a weld joint obtained by resistance spot welding of high strength steel sheets having a high tensile strength, the present inventors studied the hydrogen behavior of entering the weld metal during welding, that is, the behavior which would cause the occurrence of delayed fracture. The following findings were obtained.

As described above, first, hydrogen enters the weld during welding. Since hydrogen diffuses more slowly at lower temperatures, rapid cooling after welding allows a large proportion of hydrogen to remain in the nugget without diffusing. Then, as time proceeds, hydrogen collects at a portion where large tensile stress concentrates, such as a notched end portion of the nugget. This results in delayed fracture.

An effective way to suppress delayed fracture is to release more hydrogen from the nugget during welding and reduce the amount of residual hydrogen in the nugget.

Accordingly, the present inventors tried to identify preferred conditions for resistance spot welding under which the amount of residual hydrogen in the weld can be reduced. The results will be given below.

In a welding process, by producing spatter first at the interface of steel sheets, a hydrogen source present at the interface of the steel sheets can be discharged with spatter. It was found that this reduces mixing of hydrogen into the nugget in later stages of the welding process and improves resistance of the weld joint to delayed fracture. However, if spatter occurs in later stages of the welding process, it is difficult to reduce hydrogen mixed into the nugget before the occurrence of spatter. This may hinder suppression of delayed fracture, affect the growth of the nugget, and make it difficult to provide a large nugget diameter.

Accordingly, the welding process was divided into two steps: a first welding step (or initial welding step described below) intended to produce spatter, and a second welding step (or main welding step described below) intended to form a nugget after the first welding step. This enabled spatter to be produced at the initial stage of the welding process, and made it possible to suppress spatter at later stages of the welding process.

Also, contact resistance at the interface of steel sheets in the initial stage of the welding process was used to selectively melt only a portion near the steel sheet surface where a hydrogen source was present, so as to produce spatter of a minimum level necessary. This enabled efficient release of hydrogen. It was then found that to achieve this, it was important to appropriately control the welding force and the current value in the first welding step (initial welding step).

By setting the first welding step (initial welding step) described above, moisture and oil content present at the interface of steel sheets, or adhering substances such as soils, were discharged together with spatter. As the result, it was possible to keep the interface of steel sheets clean, and moderately soften the steel sheets with heat by passing current therethrough before formation of a nugget. This made it possible to maintain good contact between steel sheets and it was found that the effect of improving resistance to delayed fracture was achieved. Additionally, it was found that in the second welding step (main welding step), the effect of stably forming a nugget having a large diameter was also achievable.

Aspects of the present invention have been made on the basis of the findings described above and can be summarized as follows.

[1] One aspect of the present invention provides a resistance spot welding method for joining two or more steel sheets including at least one steel sheet having a tensile strength of 980 MPa or higher. The resistance spot welding method involves placing the steel sheets on top of each other to form a set of steel sheets to be welded, clamping the set of steel sheets with a pair of electrodes, and passing a current through the steel sheets while applying pressure thereto to join the steel sheets together. The resistance spot welding method includes an initial welding step of welding by passing a current I₁ (kA) satisfying relation (2) while applying a welding force F₁ (kN) satisfying relation (1):

0.2×√t₁<F₁≤4×√t₁ (1)

2×√F₁<I₁≤10×√F₁ (2)

where t₁ is a total sheet thickness (mm) of the steel sheets to be welded; and a main welding step of forming a nugget having a predetermined nugget diameter. Spatter is produced in the initial welding step.

[2] In the resistance spot welding method of [1], a welding time in the initial welding step is 10 ms or more and within 200 ms.

[3] The resistance spot welding method of [1] or [2] further includes a cooling step between the initial welding step and the main welding step. The cooling step is a step of welding at a current I_{c} (kA) satisfying relation (3):

0≤I_{c}≤I₁ (3)

where I_{c} is a current (kA) in the cooling step and I₁ is a current (kA) in the initial welding step.

[4] In the resistance spot welding method of any one of [1] to [3], a welding voltage Vs (V) at the time of occurrence of the spatter satisfies relation (4):

Vs≥0.7×Va (4)

where Va is a welding voltage (V) 5 ms before occurrence of the spatter, and Vs is a welding voltage (V) at the time of occurrence of the spatter.

[5] One aspects of the present invention provides a method for producing a resistance spot weld joint using the resistance spot welding method of any one of [1] to [4].

Aspects of the present invention have high industrial advantages in that it enables stable formation of a large diameter nugget, as well as suppression of delayed fracture in the weld.

### BRIEF DESCRIPTION OF THE DRAWINGS

FIG. 1 is a cross-sectional view schematically illustrating resistance spot welding according to an embodiment of the present invention.

FIG. 2(a) and FIG. 2(b) are diagrams illustrating an exemplary weld joint used in Examples of the present invention, FIG. 2(a) being a plan view of the weld joint, FIG. 2(b) being a lateral view of the weld Mint.

### DETAILED DESCRIPTION OF EMBODIMENTS OF THE INVENTION

Hereinafter, a resistance spot welding method and a method for producing a resistance spot weld joint according to aspects of the present invention will be described with reference to the drawings. The present invention is not limited to the embodiments to be described.

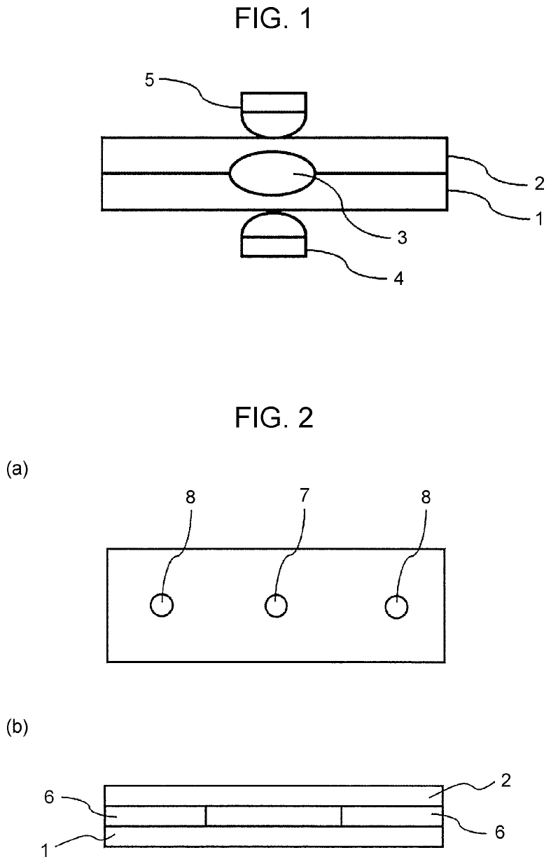

First, a resistance spot welding method according to aspects of the present invention will be described with reference to FIG. 1.

Aspects of the present invention provide a technique in which two or more steel sheets are joined by resistance spot welding. FIG. 1 schematically illustrates an exemplary resistance spot welding method. FIG. 1 illustrates an example in which resistance spot welding is performed on two steel sheets.

First, two or more steel sheets are placed on top of each other. In the example illustrated in FIG. 1, two steel sheets including a steel sheet (which may hereinafter be referred to as a lower steel sheet 1) on the lower side and a steel sheet (which may hereinafter be referred to as an upper steel sheet 2) on the upper side, are placed on top of each other to form a set of steel sheets to be welded.

Next, the steel sheets (the lower steel sheet 1 and the upper steel sheet 2) on top of each other are clamped by a pair of welding electrodes (electrodes) 4 and 5 disposed on the lower and upper sides of the steel sheets, respectively. A current is then passed through the lower steel sheet 1 and the upper steel sheet 2 in a predetermined pattern (described below) while pressure is being applied thereto. In the example illustrated in FIG. 1, the electrode disposed on the lower side of the steel sheets is referred to as a lower electrode 4, and the electrode disposed on the upper side of the steel sheets is referred to as an upper electrode 5.

With the steel sheets on top of each other being clamped by the pair of welding electrodes 4 and 5, a nugget 3 of a required size is formed by resistive heating by passing a current through the steel sheets on top of each other while applying pressure thereto, and the steel sheets on top of each other are joined together so that a weld joint is obtained. While not shown, in accordance with aspects of the present invention, three or more steel sheets placed on top of each other may be welded by resistance spot welding. In this case also, a weld joint can be obtained by the same welding method as that described above.

An apparatus used to implement the resistance spot welding method according to aspects of the present invention is not limited to a particular type. The apparatus may have any configuration as long as it is capable of applying pressure by the lower electrode 4 and the upper electrode 5 and controlling the welding force applied by the lower electrode 4 and the upper electrode 5. For example, a conventionally known device, such as an air cylinder or a servomotor, may be used. A configuration of supplying current during welding and controlling the current value is also not particularly limited, and a conventionally known device may be used. Aspects of the present invention are applicable both in the case of direct current and alternating current. In the case of using alternating current, the term “current” refers to “effective current”.

The shape of the tip of the lower electrode 4 and the upper electrode 5 is not limited to a particular one. Examples of the electrode tip shape include a dome-radius (DR) shape, a radius (R) shape, and a dome (D) shape described in JIS C 9304: 1999. The tip diameter of the lower electrode 4 and the upper electrode 5 is, for example, from 4 mm to 16 mm. Resistance spot welding is performed while the electrodes are being continuously cooled by water.

In accordance with aspects of the present invention, the steel type of steel sheets to be resistance spot welded is not limited to a particular one. At least one of the steel sheets to be placed on top of each other is a high strength steel sheet having a tensile strength of 980 MPa or higher. This is because delayed fracture in resistance spot welds tends to be a problem particularly in high strength steel sheets having a tensile strength of 980 MPa or higher. This means that advantageous effects according to aspects of the present invention are of particular benefit to a case of using such high strength steel sheets.

The sheet thickness of steel sheets to be resistance spot welded is not particularly limited. For example, the sheet thickness is preferably 0.5 mm or more and 3.0 mm or less. This is because steel sheets having a sheet thickness within this range can be suitably used as automobile components.

The steel sheets to be resistance spot welded may each be plated to have a coated layer on the surface thereof. Examples of plating that can be used in accordance with aspects of the present invention include Zn plating and Al plating. Examples of Zn plating include hot-dip galvanization (GI), Zn—Ni plating, and Zn—Al plating. Examples of Al plating include Al—Si plating (e.g., Al—Si plating containing 10% to 20% Si by mass). The hot-dipped layer may be an alloyed hot-dipped layer. Examples of the alloyed hot-dipped layer include a galvannealed (GA) layer.

The two or more steel sheets to be resistance spot welded may either be same or different. That is, the steel sheets may be of the same type and shape, or may be of different types and shapes. A surface-treated steel sheet having a coated layer and a steel sheet having no coated layer may be placed on top of each other.

A pattern of passing a current in the resistance spot welding method according to aspects of the present invention will now be described.

Aspects of the present invention provide a resistance spot welding method for joining two or more steel sheets that include at least one steel sheet having a tensile strength of 980 MPa or higher. The resistance spot welding method involves placing the steel sheets on top of each other to form a set of steel sheets to be welded, clamping the set of steel sheets to be welded with a pair of electrodes, and passing a current through the steel sheets while applying pressure thereto to form a nugget and join the steel sheets placed on top of each other (i.e., steel sheets to be welded) together. In the example illustrated in FIG. 1, the steel sheets 1 and 2 clamped by the lower electrode 4 and the upper electrode 5 are welded by passing a current therethrough in a particular pattern while applying pressure thereto. The welding according to aspects of the present invention includes an initial welding step and a main welding step intended to form a nugget having a predetermined nugget diameter.

First, the initial welding step produces spatter in the initial welding step by performing control such that a current I₁ (kA) satisfying relation (2) (described below) is passed while a welding force F₁ (kN) satisfying relation (1) (described below) is being applied. That is, in the initial welding step, a hydrogen source present at the interface of the steel sheets is discharged together with spatter, and good contact between the steel sheets is maintained.

In accordance with aspects of the present invention, it is important to produce spatter in the initial welding step. If spatter occurs in any step (e.g., a cooling step or a main welding step described below) that follows the initial welding step, a large amount of hydrogen is mixed into the nugget before occurrence of the spatter. Since this makes it difficult to achieve a hydrogen reducing effect expected from the occurrence of spatter, a delayed fracture suppressing effect cannot be achieved. An effective way to enhance the hydrogen reducing effect is to reduce the welding time preceding the occurrence of spatter and minimize the entry of hydrogen.

In accordance with aspects of the present invention, it is preferable to produce spatter within 200 ms of the start of welding in the initial welding step. It is more preferable to produce spatter within 100 ms of the start of welding in the initial welding step. The minimum time from the start of welding to the occurrence of spatter is not limited to a particular length, but it is preferable that it be 20 ms or more.

To stably form a large diameter nugget in the main welding step described below, it is preferable that the spatter produced in the initial welding step be low-level spatter (which may hereinafter be referred to as minor spatter). Since the occurrence of spatter reduces interelectrode resistance, a voltage drop appears as a measured value when a voltage between electrodes is measured in resistance spot welding. In accordance with aspects of the present invention, the level of spatter can be controlled by controlling the amount of voltage drop at the occurrence of spatter. Specifically, the current value and the welding force in the initial welding step are preferably set such that an interelectrode voltage (welding voltage) Vs (V) at the time of occurrence of spatter satisfies the following relation (4):

Vs≥0.7×Va (4)

where Va is an interelectrode voltage (welding voltage) (V) 5 ms before the occurrence of spatter, and Vs is an interelectrode voltage (welding voltage) (V) at the time of occurrence of spatter. The spatter produced in welding that satisfies relation (4) refers to minor spatter in accordance with aspects of the present invention.

If the interelectrode voltage Vs (V) at the time of occurrence of spatter is less than (0.7×Va), the level of spatter is too large to maintain good welding conditions in the main welding step. A nugget having a large nugget diameter (which may hereinafter be referred to as “diameter”) cannot be stably formed in this case. It is thus preferable that the interelectrode voltage Vs (V) at the time of occurrence of spatter be (0.7×Va) or more. Minimizing the level of spatter is an effective way to maintain good contact between the steel sheets and enhance the effect of stably forming a large diameter nugget in the main welding step. Therefore, it is more preferable that the interelectrode voltage Vs (V) at the time of occurrence of spatter be (0.8×Va) or more. As described above, an interelectrode voltage generally drops when spatter occurs in spot welding. That is, there is no chance that the occurrence of spatter will increase the interelectrode voltage. It is thus unlikely that the interelectrode voltage Vs (V) will be (1.0×Va) or more in relation (4). Accordingly, it is preferable that the interelectrode voltage Vs (V) be less than (1.0×Va).

The initial welding step, described above, is followed by the main welding step that is intended to form a nugget having a predetermined diameter. Current passing conditions, such as a current value and a welding time, and pressure application conditions for forming such a nugget in the main welding step, are not particularly limited. Conventional welding conditions can be used here.

For example, to form a nugget having an appropriate diameter, a current value in the main welding step is preferably 1.0 kA or more and 15.0 kA or less, and a welding force in the main welding step is preferably 1.0 kN or more and 9.0 kN or less. A welding time in the main welding step is preferably 100 ms or more and 1000 ms or less. The main welding step may be a step in which the current value and the welding force are varied in multiple stages.

For cooling a molten nugget, the main welding step may be followed by a retaining step which involves retaining pressure without passing current. Although the duration of the retaining step is not specified here, it is preferable that the duration of the retaining step be in the range of 20 ms to 1000 ms as in a typical resistance spot welding process.

In accordance with aspects of the present invention, a nugget having a predetermined nugget diameter is preferably a nugget that has a nugget diameter of 3√t to 6√t (t: sheet thickness) (mm). When steel sheets of different sheet thicknesses are placed on top of each other and welded, the sheet thickness of a thinner one of two adjacent steel sheets to be joined is represented by the letter “t” described above.

In accordance with aspects of the present invention, a cooling step (described below) may be added between the initial welding step and the main welding step.

Welding conditions in the initial welding step for implementing the resistance spot welding method according to aspects of the present invention will now be described in detail. In the initial welding step, the welding force F₁ (kN) and the current I₁ (kA) are set to satisfy relation (1) and relation (2):

0.2×√t₁<F₁≤4×√t₁ (1)

2×√F₁<I₁≤10×√F₁ (2)

where t₁ is a total sheet thickness (mm) of steel sheets to be welded.

The conditions described above are necessary in the initial welding step to discharge, as spatter, some portion melted by contact resistance near the interface of steel sheets.

If the welding force F₁ (kN) is (0.2×√t₁) or less, the welding force is too small to control the melting heat generated by passage of current. This causes spatter of an extremely high level, and makes it difficult to stably form a large nugget in the main welding step that follows. If the welding force F₁ (kN) exceeds (4×√t₁), it is difficult to discharge, as spatter, some portion melted by contact resistance. This means that the effect of suppressing delayed fracture cannot be achieved. Although application of high current may produce spatter, the level of the spatter is extremely high in this case. This makes it difficult to stably form a large nugget in the main welding step that follows.

If the current I₁ (kA) is (2×√F₁) or less, it is difficult to produce spatter, and the effect of suppressing delayed fracture cannot be achieved. If the current I₁ (kA) exceeds (10×√F₁), the resulting occurrence of extremely large spatter makes it difficult to stably form a large diameter nugget in the main welding step that follows. To enhance the effect of suppressing delayed fracture and the effect of stably forming a large diameter nugget in the main welding step that follows, it is preferable to set the welding force F₁ (kN) and the current I₁ (kA) to satisfy relation (5) and relation (6):

0.5×√t₁<F₁≤2×√t₁ (5)

3×√F₁<I₁≤8×√F₁ (6)

The welding time in the initial welding step is preferably set to be 10 ms or more and within 200 ms. If the welding time is less than 10 ms, the welding time is too short to stably produce spatter, and the effect of suppressing delayed fracture cannot be stably achieved. Generation of heat from contact resistance generally takes place in the early stage of welding. In accordance with aspects of the present invention, spatter is produced in the stage of generation of heat from contact resistance. In this case, a prolonged process of welding after the occurrence of spatter not only causes an unnecessary increase in welding time, but also leads to the occurrence of a high level of spatter. For these reasons, the welding time is preferably within 200 ms, more preferably 20 ms or more and within 140 ms, and still more preferably 20 ms or more and within 100 ms.

In accordance with aspects of the present invention, a cooling step may be added between the initial passing current step and the main welding step. The cooling step involves welding at a current I_{c} (kA) satisfying relation (3) to stabilize the contact between steel sheets:

0≤I_{c}≤I₁ (3)

where I_{c} is a current (kA) in the cooling step and I₁ is a current (kA) in the initial welding step.

By adding the cooling step, the state of contact between steel sheets temporarily disturbed by spatter can be stabilized again. This ensures more stable formation of a nugget in the main welding step that follows. If the current I_{c} (kA) in the cooling step exceeds the current I₁ (kA) in the initial welding step, the chance of occurrence of spatter in the cooling step increases, and the effect of maintaining the state of contact between steel sheets may not be achieved. The cooling step is intended to stabilize the state of contact between steel sheets without producing spatter in the cooling step. If the current I_{c} in the cooling step simply satisfies relation (3), the passing current pattern in the cooling step is not limited to a particular one, and may be a non-passing current step involving no passage of current, a multi-stage passing current step, or a downslope passing current step. The current I_{c} (kA) in the cooling step is more preferably (0.5×I₁) kA or less.

The duration of the cooling step is preferably 500 ms or less. If passing current is performed for longer than 500 ms in the cooling step, the resulting increase in overall duration of the welding process may lead to low productivity. The duration of the cooling step is more preferably 300 ms or less, and more preferably 20 ms or more.

A method for producing a resistance spot weld joint will now be described.

Aspects of the present invention provide a method for producing a resistance spot weld joint using the resistance spot welding method described above. In the method for producing a resistance spot weld joint according to aspects of the present invention, for example, two or more steel sheets including at least one steel sheet having a tensile strength of 980 MPa or higher are placed on top of each other, clamped by a pair of welding electrodes, and resistance spot welded to form a nugget of a required size by passing a current through, while applying pressure to, the steel sheets under the welding conditions for each of the steps described above and a resistance spot weld joint is produced. The steel sheets, the welding conditions and so on will not be described here, as they are the same as those described above.

As described above, aspects of the present invention make it possible to suppress delayed fracture in welds. Also, since low-level spatter satisfying the interelectrode voltage condition, described above, is produced in the initial welding step, a nugget having a large diameter can be stably formed in the main welding step that follows.

Also, aspects of the present invention make it possible to effectively suppress entry of hydrogen into weld metal that is highly sensitive to hydrogen embrittlement. Therefore, the advantageous effects described above are achieved not only in resistance spot welding of high strength steel sheets for automobiles, but also in resistance spot welding of other types of steel sheets.

### EXAMPLES

The operations and effects according to aspects of the present invention will now be described using Examples. Note that the present invention is not limited to Examples described below.

In Examples of the present invention, as described with reference to FIG. 1, the lower steel sheet 1 and the upper steel sheet 2 were placed on top of each other and welded by resistance spot welding. The resistance spot welding was performed at room temperature, with the lower electrode 4 and the upper electrode 5 being continuously cooled by water. The lower electrode 4 and the upper electrode 5 used here were DR chromium copper electrodes both having a diameter (tip diameter) of 6 mm and a curvature radius of 40 mm at the tip. The lower electrode 4 and the upper electrode 5 were driven by a servomotor to control the welding force, and an alternating-current power supply with a frequency of 50 Hz was used in welding.

Steel sheets to be welded were of three steel types as follows:

[Steel Type I] A non-plated steel sheet with a tensile strength of 1470 MPa, 100 mm long on the longer side, 30 mm long on the shorter side, and 1.0 mm in sheet thickness;

[Steel Type II] A steel sheet with a tensile strength of 1470 MPa, 100 mm long on the longer side, 30 mm long on the shorter side, 1.6 mm in sheet thickness, and plated (hot-dip galvanized (GI) with a coating weight of 50 g/m² on one side); and

[Steel Type III] A steel sheet with a tensile strength of 1320 MPa, 100 mm long on the longer side, 30 mm long on the shorter side, 2.0 mm in sheet thickness, and plated (hot-dip galvanized (GI) with a coating weight of 50 g/m² on one side).

A weld joint used in a test will be described with reference to FIG. 2(a) and FIG. 2(b).

FIG. 2(a) is a plan view of a weld joint and FIG. 2(b) is a lateral view of the weld joint. In resistance spot welding, as illustrated in FIG. 2(a) and FIG. 2(b), the two steel sheets 1 and 2 (100 mm long on the longer side and 30 mm long on the shorter side) of the steel types described above were tack welded, with spacers 6 interposed therebetween on both sides. The spacers 6 are 1.6 mm thick and 30 mm long on all four sides. Then, the two steel sheets placed on top of each other to form a sheet set were welded at the center under the conditions shown in Table 1. As illustrated in FIG. 2(a), the sheet set was tack welded at tack weld points 8 at both ends thereof, and welded at a weld point 7 in the center thereof.

Welding was performed by adjusting the current value such that the nugget diameter was about 3.5√t (t: sheet thickness (mm)) (mm) in all examples and comparative examples. Welding of 1.6 mm thick steel sheets provides a nugget diameter of 3.5√t=4.43 mm. For welding of steel sheets of different sheet thicknesses, the current value was adjusted such that the nugget diameter was 3.5√t, on the basis of the sheet thickness of a thinner steel sheet.

Delayed fracture characteristics and nugget stability were evaluated by the method described below.

Delayed fracture characteristics were evaluated in the following manner.

In the delayed fracture test, each weld joint obtained was left to stand in the atmosphere at room temperature (20° C.) for 24 hours. Then, the weld was checked for delayed fracture. Welding was performed with n=3 in all examples and comparative examples. Referring to Table 2, the weld joints exhibiting no delayed fracture after being left to stand for 24 hours are indicated by the symbol “O”, whereas the weld joints exhibiting delayed fracture are indicated by the symbol “x”.

As for the determination of delayed fracture characteristics, if split of a nugget (or phenomenon of splitting of a nugget into two at the interface) was visually observed after welding, the weld joint was determined to have delayed fracture. The final determination of delayed fracture characteristics is shown in Table 2. As shown, a set of conditions under which none of the three weld joints (n=3) had delayed fracture is indicated as “A (excellent)”, whereas a set of conditions under which at least one of the three weld joints (n=3) had delayed fracture is indicated as “E (fail)”.

By using the same specimens as those described above, nugget stability was evaluated in the following manner.

Each weld joint obtained was cut at the center of the weld and etched by applying a picric acid aqueous solution to the cross section. Then, the length of the microstructure of the etched nugget was measured to calculate the nugget diameter. The nugget diameter was calculated with n=3 in all the conditions. Referring to Table 2, the weld joints with a nugget diameter of 3.5√t or more are indicated by the symbol “O”, whereas the weld joints with a nugget diameter of less than 3.5√t are indicated by the symbol “x”.

The determination of nugget stability is shown in Table 2. As shown, a set of conditions under which all the three weld joints (n=3) had a nugget diameter of 3.5√t or more is indicated as “A (excellent)”, whereas a set of conditions under which at least one of the three weld joints (n=3) had a nugget diameter of less than 3.5√t is indicated as “B (fail)”.

TABLE 1

| | | | Welding Conditions | | | | | |
|---|---|---|---|---|---|---|---|---|
| | | | Initial Welding Step | | | Cooling Step | | Main Welding Step |
| | | | Welding | | Welding | | Cooling | Welding |
| | Upper | Lower | Force | Current | Time | Current I_{c} | Time | Force |
| No. | Sheet | Sheet | F₁ (kN) | I₁ (kA) | (ms) | (kA) | (ms) | (kN) |
| 1 | I | I | 1.0 | 6.0 | 80 | 0.0 | 60 | 3.0 |
| 2 | I | I | 1.0 | 6.0 | 80 | 0.0 | 60 | 3.0 |
| 3 | I | I | 1.0 | 12.0 | 80 | 0.0 | 60 | 3.0 |
| 4 | I | I | 1.0 | 6.0 | 80 | Downslope | 100 | 3.0 |
| 5 | I | I | 3.0 | 9.0 | 80 | — | — | 3.0 |
| 6 | I | I | 3.0 | 3.0 | 80 | — | — | 3.0 |
| 7 | I | I | 0.6 | 9.0 | 100 | — | — | 3.0 |
| 8 | I | II | 1.5 | 7.0 | 80 | 1.0 | 60 | 3.0 |
| 9 | I | II | 1.5 | 7.0 | 80 | 1.0 | 60 | 3.0 |
| 10 | I | II | 3.0 | 10.0 | 60 | — | — | 3.0 |
| 11 | I | II | 7.0 | 15.0 | 60 | — | — | 3.0 |
| 12 | II | II | 2.0 | 7.0 | 80 | 0.0 | 60 | 4.0 |
| 13 | II | II | 3.0 | 10.0 | 60 | — | — | 3.0 |
| 14 | II | II | 3.0 | 10.0 | 60 | 0.0 | 60 | 3.0 |
| 15 | III | III | 3.5 | 10.0 | 60 | 0.0 | 100 | 5.0 |
| | | | | | | Spatter Behavior | | |
| | | Welding Conditions | | | | Time from | | |
| | | | | Retaining | | Welding | | |
| | | Main Welding Step | | Step | | Start to | | |
| | | | Welding | Retention | Step where | Spatter | Voltage | |
| | | Current | Time | Time | Spatter | Occurrence | Drop | |
| | No. | I₂ (kA) | (ms) | (ms) | Occurred | (ms) | Vs/Va | Remarks |
| | 1 | 6.8 | 300 | 20 | Initial Welding Step | 40 | 0.9 | Example of Invention |
| | 2 | 6.8 | 300 | 100 | Initial Welding Step | 40 | 0.9 | Example of Invention |
| | 3 | 6.8 | 300 | 20 | Initial Welding Step | 40 | 0.6 | Comparative Example |
| | 4 | 6.8 | 300 | 20 | Initial Welding Step | 40 | 0.9 | Example of Invention |
| | 5 | 6.8 | 300 | 20 | Initial Welding Step | 40 | 0.9 | Example of Invention |
| | 6 | 6.8 | 300 | 20 | — | No spatter | — | Comparative Example |
| | 7 | 6.8 | 300 | 20 | Initial Welding Step | 40 | 0.6 | Comparative Example |
| | 8 | 7.2 | 300 | 20 | Initial Welding Step | 40 | 0.9 | Example of Invention |
| | 9 | 7.2 | 300 | 200 | Initial Welding Step | 40 | 0.9 | Example of Invention |
| | 10 | 7.3 | 300 | 20 | Initial Welding Step | 40 | 0.8 | Example of Invention |
| | 11 | 7.3 | 300 | 20 | Initial Welding Step | 40 | 0.6 | Comparative Example |
| | 12 | 7.5 | 300 | 20 | Initial Welding Step | 20 | 0.9 | Example of Invention |
| | 13 | 7.5 | 300 | 20 | Initial Welding Step | 40 | 0.9 | Example of Invention |
| | 14 | 7.5 | 300 | 20 | Initial Welding Step | 40 | 0.9 | Example of Invention |
| | 15 | 7.5 | 300 | 20 | Initial Welding Step | 40 | 0.8 | Example of Invention |

TABLE 2

| | Test Result | | | | | | | | |
|---|---|---|---|---|---|---|---|---|---|
| | | | | Delayed | | | | | |
| | Delayed Fracture Test | | | Fracture | Diameter Of a Nugget | | | Nugget | |
| | 1st | 2nd | 3rd | Characteristics | 1st | 2nd | 3rd | Stability | |
| No. | Time | Time | Time | (*1) | Time | Time | Time | (*1) | Remarks |
| 1 | ∘ | ∘ | ∘ | A | ∘ | ∘ | ∘ | A | Example of |
| | | | | | | | | | Invention |
| 2 | ∘ | ∘ | ∘ | A | ∘ | ∘ | ∘ | A | Example of |
| | | | | | | | | | Invention |
| 3 | ∘ | ∘ | ∘ | A | ∘ | x | x | B | Comparative |
| | | | | | | | | | Example |
| 4 | ∘ | ∘ | ∘ | A | ∘ | ∘ | ∘ | A | Example of |
| | | | | | | | | | Invention |
| 5 | ∘ | ∘ | ∘ | A | ∘ | ∘ | ∘ | A | Example of |
| | | | | | | | | | Invention |
| 6 | x | x | x | B | ∘ | ∘ | ∘ | A | Comparative |
| | | | | | | | | | Example |
| 7 | ∘ | ∘ | x | B | x | x | ∘ | B | Comparative |
| | | | | | | | | | Example |
| 8 | ∘ | ∘ | ∘ | A | ∘ | ∘ | ∘ | A | Example of |
| | | | | | | | | | Invention |
| 9 | ∘ | ∘ | ∘ | A | ∘ | ∘ | ∘ | A | Example of |
| | | | | | | | | | Invention |
| 10 | ∘ | ∘ | ∘ | A | ∘ | ∘ | ∘ | A | Example of |
| | | | | | | | | | Invention |
| 11 | ∘ | ∘ | ∘ | A | ∘ | x | x | B | Comparative |
| | | | | | | | | | Example |
| 12 | ∘ | ∘ | ∘ | A | ∘ | ∘ | ∘ | A | Example of |
| | | | | | | | | | Invention |
| 13 | ∘ | ∘ | ∘ | A | ∘ | ∘ | ∘ | A | Example of |
| | | | | | | | | | Invention |
| 14 | ∘ | ∘ | ∘ | A | ∘ | ∘ | ∘ | A | Example of |
| | | | | | | | | | Invention |
| 15 | ∘ | ∘ | ∘ | A | ∘ | ∘ | ∘ | A | Example of |
| | | | | | | | | | Invention |

*1A: Excellent, B: Fail

In Examples of invention, as can be seen in Table 2, the effect of stably forming a nugget was achieved while the occurrence of delayed fracture in a weld joint was suppressed.

### REFERENCE SIGNS LIST

1: lower steel sheet
2: upper steel sheet
3: nugget
4: lower electrode
5: upper electrode
6: spacer
7: weld point
8: tack weld point

1. A resistance spot welding method for joining two or more steel sheets including at least one steel sheet having a tensile strength of 980 MPa or higher, the method involving placing the steel sheets on top of each other to form a set of steel sheets to be welded, clamping the set of steel sheets with a pair of electrodes, and passing a current through the steel sheets while applying pressure thereto to join the steel sheets together, the resistance spot welding method comprising:
an initial welding step of welding by passing a current I₁ (kA) satisfying relation (2) while applying a welding force F₁ (kN) satisfying relation (1),
0.2×√t₁<F₁≤4×√t₁ (1)
2×√F₁<I₁≤10×√F₁ (2)
where t₁ is a total sheet thickness (mm) of the steel sheets to be welded; and
a main welding step of forming a nugget having a
predetermined nugget diameter,
wherein spatter is produced in the initial welding step.

2. The resistance spot welding method according to claim 1, wherein a welding time in the initial welding step is 10 ms or more and within 200 ms.

3. The resistance spot welding method according to claim 1, further comprising a cooling step between the initial welding step and the main welding step, the cooling step being a step of welding at a current I_{c} (kA) satisfying relation (3):
0≤I_{c}≤I₁ (3)
where I_{c} is a current (kA) in the cooling step and I₁ is a current (kA) in the initial welding step.

4. The resistance spot welding method according to claim 2, further comprising a cooling step between the initial welding step and the main welding step, the cooling step being a step of welding at a current I_{c} (kA) satisfying relation (3):
0≤I_{c}≤I₁ (3)
where I_{c} is a current (kA) in the cooling step and I₁ is a current (kA) in the initial welding step.

5. The resistance spot welding method according to claim 1, wherein a welding voltage Vs (V) at the time of occurrence of the spatter satisfies relation (4):
Vs≥0.7×Va (4)
where Va is a welding voltage (V) 5 ms before occurrence of the spatter, and Vs is a welding voltage (V) at the time of occurrence of the spatter.

6. The resistance spot welding method according to claim 2, wherein a welding voltage Vs (V) at the time of occurrence of the spatter satisfies relation (4):
Vs≥0.7×Va (4)
where Va is a welding voltage (V) 5 ms before occurrence of the spatter, and Vs is a welding voltage (V) at the time of occurrence of the spatter.

7. The resistance spot welding method according to claim 3, wherein a welding voltage Vs (V) at the time of occurrence of the spatter satisfies relation (4):
Vs≥0.7×Va (4)
where Va is a welding voltage (V) 5 ms before occurrence of the spatter, and Vs is a welding voltage (V) at the time of occurrence of the spatter.

8. The resistance spot welding method according to claim 4, wherein a welding voltage Vs (V) at the time of occurrence of the spatter satisfies relation (4):
Vs≥0.7×Va (4)
where Va is a welding voltage (V) 5 ms before occurrence of the spatter, and Vs is a welding voltage (V) at the time of occurrence of the spatter.

9. A method for producing a resistance spot weld joint using the resistance spot welding method according to claim 1.

10. A method for producing a resistance spot weld joint using the resistance spot welding method according to claim 2.

11. A method for producing a resistance spot weld joint using the resistance spot welding method according to claim 3.

12. A method for producing a resistance spot weld joint using the resistance spot welding method according to claim 4.

13. A method for producing a resistance spot weld joint using the resistance spot welding method according to claim 5.

14. A method for producing a resistance spot weld joint using the resistance spot welding method according to claim 6.

15. A method for producing a resistance spot weld joint using the resistance spot welding method according to claim 7.

16. A method for producing a resistance spot weld joint using the resistance spot welding method according to claim 8.
